(19) United States
(12) Patent Application Publication
(10) Pub. No.: US 2005/0031771 A1
(43) Pub. Date: Feb. 10, 2005

(54) Process for flavor improvement of foodstuffs

(76) Inventor: Devin G. Peterson, State College, PA (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/896,624

(22) Filed: Jul. 22, 2004

Related U.S. Application Data
(60) Provisional application No. 60/489,973, filed on Jul. 25, 2003.

(51) Int. Cl. A23K 1/175

(52) U.S. Cl. 426/650

(57) ABSTRACT

The development of flavor compounds in a food is controlled by adding a flavonoid compound to the food. The flavonoid compound may comprise a phenolic compound, and specific phenolic compounds comprise catechins such as epicatechin, epigallocatechin gallate and similar compounds. Further disclosed herein is the control of the development of flavor compounds in a food during processing or storage by control of the Maillard reaction and/or by scavenging pyrazine radicals in the food. Such control may be achieved through the use of flavonoid compounds.

### RELATED APPLICATION

This application claims priority of U.S. Provisional Patent Application Ser. No. 60/489,973 filed Jul. 25, 2003 and entitled “Process for Flavor Improvement of Foodstuffs.”

### GOVERNMENT SPONSORSHIP

This work was supported by the USDA under Grant No. PEN3936. Accordingly, the U.S. Government may have certain rights in this invention.

### FIELD OF THE INVENTION

The present invention relates to methods for controlling the formation of flavor/off-flavor compounds in food and beverages during storage and/or thermal processing.

### BACKGROUND OF THE INVENTION

Numerous food products and commodities employ a heat processing step in the production cycle as a means of improving food preservation, product safety, eating quality (of food consumed in the cooked form), and ease of distribution (e.g. cereal-based products, fluid milk, canned milk, powdered milk, whey and casein protein isolates, cocoa, and fruit-based products). Thermal processing techniques include cooking, pasteurization, commercial sterilization, drying operations (removal of moisture) and extrusion. Thermally activated reactions can also proceed at room temperatures and at moderately elevated temperatures which are encountered during shipping and storage of food products. Accordingly, storage and shipping are included in the broad term “thermal processing” as used herein, since the principles of the present invention may be advantageously employed to preserve the flavor of foods being shipped or stored.

Heat-induced formation of flavor/off-flavor compounds in foodstuffs (i.e. food and beverage products) can occur through multiple pathways such as lipid oxidation, Maillard reaction (between nitrogen-containing compounds and carbonyl-containing compounds) and the like, either singly or in combination. Since these pathways are heat catalyzed, thermal processing of food and beverage products often results in changes to their flavor properties, thereby affecting the overall product quality.

A common problem associated with the thermal processing of various food and beverage products is the simultaneous generation of flavor/off-flavor compounds that ultimately result in the development of negative product traits. The ability to control or limit the generation of such compounds during thermal treatment would therefore enhance their product value.

The control of lipid oxidation during food and beverage processing and storage has conventionally been accomplished with antioxidant compounds such as Vitamin E or synthetic compounds such as BHT, BHA, TBHQ, and alkyl gallates. More recently natural sources of antioxidants for the control of lipid oxidation have been explored (Medina et al. 1999. Comparison of Natural Polyphenol Antioxidants from Extra Virgin Olive Oil with Synthetic Antioxidants in Tuna Lipids During Thermal Oxidation. J. Agric. Food Chem. 47: 4873-4879). An alternative to the use of traditional antioxidants for lipid oxidation is provided in U.S. Pat. No. 4,259,364 which teaches the use of a solution of aqueous bromate or iodate salt to oxidize flavor precursors. It is conceivable that this reduction in off-flavor could be simply due to the reduction in the degree of unsaturation of any lipid residue remaining (i.e. lipoprotein, glycoprotein) via a halogenation reaction.

While the prior art has sought to control color formation during food processing via control of the Maillard reaction, color formation does not correlate with the generation of off-flavors; and such prior art is not directed to, and does not accomplish, flavor control. The Maillard reaction is very complex (multiple pathways), and as such, controlling parts of the reaction such as color formation can have no correlation with the flavor/off-flavor pathways of formation. International Patent No. WO/0239828 discloses a process for oxidizing (via a bioconversion) the reducing group (carbonyl) of a mono- or disaccharide, thereby limiting color formation caused by the Maillard reaction. Even though a significant difference may have been noted in color development, these results cannot be directly related to flavor/off-flavor formation. Even minute quantities of reducing sugar, which do not result in a quantifiable color change, may still supply ample precursor for flavor generation in food and beverage products. The principal disadvantages of this method are that many food and beverage products use reducing sugars as a sweetener and/or for caloric value.

Two processes have been disclosed for removing the “cooked” flavor from a specific commodity which has been heated to temperatures in excess of 150-155° F., namely, milk. U.S. Pat. No. 4,053,644 utilizes immobilized enzymes (sulfhydryl oxidase) to reduce the cooked flavor in heated milk (after UHT processing). This process oxidizes sulfhydryl-containing compounds. A primary disadvantage of this method is that sulfhydryl-containing compounds are only a small portion of the flavor/off-flavor compounds generated when milk is heated, therefore the method has a limited ability to remove the thermally generated flavor/off-flavor compounds. Furthermore, many of these sulfhydryl-containing compounds auto-oxidize during storage and therefore decrease naturally over time.

The second process for minimizing “cooked” flavor in heated milk is described in U.S. Pat. No. 4,851,251 and involves a masking agent (caraway seeds). Masking agents are typically limited in their ability to abate thermally generated flavor properties. In addition, they suppress the native (non-processed) flavor attributes, which can be undesirable, and lower the overall product quality. Finally, masking agents also supply undesirable flavor properties.

### SUMMARY OF THE INVENTION

Disclosed herein is a method for controlling the development of flavor compounds in a food. The method comprises adding a flavonoid compound to the food and heating the food. It is to be understood that the step of heating may comprise storing the food at temperatures ranging from ambient on upward. In specific embodiments, the flavonoid is a phenolic compound, which may comprise a polyphenolic compound. One specific group of polyphenolic compounds employed in the present invention comprises catechins such as epicatechin (EPC), epigallocatechin gallate (EGCG) and the like, taken either singly or in combination. The flavonoid compound may be added before the food is heated or after heating. In specific embodiments, the flavonoid is present in an amount up to 2% by weight of the food, and in certain embodiments the flavonoid compound comprises at least 0.2% by weight of the food.

In another aspect of the present invention, the development of flavor compounds during the processing or storage of foods is controlled by at least partially blocking the Maillard reaction pathway in the food, and such blocking may be accomplished by the use of a radical scavenger material, and this radical scavenger may, in some instances, comprise a flavonoid. In another aspect of the present invention, the development of flavor compounds during the processing or storage of food is controlled by scavenging pyrazine radicals in the food. Such scavenging may be accomplished by the addition of a radical scavenger to the food, and the radical scavenger may, in some embodiments, comprise a flavonoid.

### BRIEF DESCRIPTION OF THE DRAWINGS

FIG. 1 is a chart illustrating the effect of EPC on the thermal generation of flavor/off-flavor compounds via the Maillard reaction using a model reaction mixture of amino acids and monosaccharide sugars under acidic conditions (pH 6.0) for approximately 30 minutes at about 125° C. The % peak area ratio by example: 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation.

FIG. 2 is a chart illustrating the effect of EPC on the thermal generation of flavor/off-flavor compounds via the Maillard reaction using a model reaction mixture of amino acids and monosaccharide sugars under neutral conditions (pH 7.0) for approximately 30 minutes at about 125° C. The % peak area ratio by example: 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation.

FIG. 3 is a chart illustrating the effect of EPC on the thermal generation of flavor/off-flavor compounds via the Maillard reaction using a model reaction mixture of amino acids and monosaccharide sugars under basic conditions (pH 8.2) for approximately 30 minutes at about 125° C. The % peak area ratio by example: 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation.

FIG. 4 is a chart illustrating the effect of EPC on the thermal generation of flavor/off-flavor compounds via the Maillard reaction using a model reaction mixture of amino acids and monosaccharide sugars under neutral conditions (pH 7.0) for approximately 60 minutes at about 100° C. The % peak area ratio by example: 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation.

FIG. 5 is a chart illustrating the effect of EPC on the thermal generation of flavor/off-flavor compounds via the Maillard reaction using a model reaction mixture of amino acids and monosaccharide sugars under neutral conditions (pH 7.0) for approximately 15 minutes at about 125° C. The % peak area ratio by example: 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation.

FIG. 6 is a chart illustrating the effect of EPC on the thermal generation of flavor/off-flavor compounds via the Maillard reaction using a model reaction mixture of amino acids and monosaccharide sugars under neutral conditions (pH 7.0) for approximately 30 minutes at about 150° C. The % peak area ratio by example, 100%=same concentration of compound in each reaction (control & EPC enriched) or EPC did not inhibit formation, 10%=the concentration of the compound in the EPC reaction was only 10% of the concentration in the control reaction (no EPC) or EPC inhibited formation; 150%=the concentration of the compound in the EPC reaction was 150% of the concentration in the control reaction (no EPC) or EPC promoted formation.

FIG. 7 is a chart illustrating the effect of EGCG on the thermal generation of flavor/off-flavor compounds via the Maillard reaction using a model reaction mixture of amino acids and monosaccharide sugars under neutral conditions (pH 7.0) for approximately 30 minutes at about 125° C. The % peak area ratio by example: 100%=same concentration of compound in each reaction (control & EGCG enriched) or EGCG did not inhibit formation, 10%=the concentration of the compound in the EGCG reaction was only 10% of the concentration in the control reaction (no EGCG) or EGCG inhibited formation.

FIG. 8 is a chart illustrating the effect of BHT on the thermal generation of flavor/off-flavor compounds via the Maillard reaction using a model reaction mixture of amino acids and monosaccharide sugars under neutral conditions (pH 7.0) for approximately 30 minutes at about 125° C. The % peak area ratio by example: 100%=same concentration of compound in each reaction (control & BHT enriched) or BHT did not inhibit formation, 10%=the concentration of the compound in the BHT reaction was only 10% of the concentration in the control reaction (no BHT) or BHT inhibited formation.

FIG. 9 is a chart illustrating the effect of EPC on the thermal generation of flavor/off-flavor compounds in a granola bar model system (see Table 2) at about 191° C. for approximately 10 minutes. The % peak area ratio by example: 100%=same concentration of compound in each reaction (control & EPC enriched) or EPC did not inhibit formation, 10%=the concentration of the compound in the ECGC reaction was only 10% of the concentration in the control reaction (no EPC) or EPC inhibited formation.

FIG. 10 is a chart illustrating the effect of enrichment of EPC on the thermal generation of flavor/off-flavor compounds in unroasted cocoa nibs at approximately 145° C. for about 30 minutes. The % peak area ratio by example: 100%=same concentration of compound in each reaction (control & EPC enriched) or EPC did not inhibit formation, 10%=the concentration of the compound in the BHT reaction was only 10% of the concentration in the control reaction (no EPC) or EPC inhibited formation.

FIG. 11 is a chart illustrating the effect of EPC on the thermal generation of flavor/off-flavor compounds in fluid bovine milk as a result of being processed under standard UHT conditions. The control sample was one-day old raw bovine milk, while the treatment sample was one-day old raw bovine milk to which 0.1% EPC was added (prior to UHT processing); both samples were processed using the same standard UHT conditions.

### DETAILED DESCRIPTION OF THE INVENTION

The present invention overcomes the foregoing problems by employing flavonoid compounds, such as polyphenolic compounds, which are free radical scavengers, and/or antioxidants that can be added or released (e.g. glycosides) or removed (e.g. during fermentation) from a food or beverage product prior to thermal processing of the product in order to control common chemical pathways responsible for the formation of thermally generated flavor compounds. Examples of such polyphenolic compounds, scavengers and antioxidants include, but are not limited to, catechins such as epicatechin and epigallocatechin gallate, as well as butylated hydroxymethylphenol and the like. Not only is the method of the present invention quite unique, but the invention is applicable to a wide variety of processing conditions and food and beverage products. The invention advantageously controls an extensive range of chemical pathways responsible for flavor/off-flavor development within the Maillard reaction as well as lipid oxidation. Furthermore, natural sources of polyphenols are available and many are known health-promoting molecules, e.g. epicatechin and epigallocatechin gallate.

The present invention employs an operating temperature range of about 0° C. and higher. The concentration range of polyphenolic compounds, free radical scavengers, or antioxidants is generally up to about 2% on a mass by mass basis in a food or beverage product.

The invention will be more fully described by reference to the following examples, but which are not to be construed as limiting the scope thereof.

### EXAMPLES

### Example 1

A chemical reactor was used to study the influence of two different polyphenolic compounds, epicatechin (“EPC”) and epigallocatechin gallate (“EGCG”), as well as the influence of a common synthetic phenolic antioxidant additive in food and beverage products, butylated hydroxymethylphenol (“BHT”), on the thermal generation of flavor compounds created during the process of a mixture of known flavor precursors common in food/beverage products. Composition of the mixture is detailed in Table 1.

TABLE 1
Chemicals Used for Flavor/Off-Flavor Generation
in Thermal Reaction Model

| Reactants^{a} | Control | Treatment |
|---|---|---|
| Alanine | 0.01 M | 0.01 M |
| Glycine | 0.01 M | 0.01 M |
| Leucine | 0.01 M | 0.01 M |
| Isoleucine | 0.01 M | 0.01 M |
| Glucose | 0.02 M | 0.02 M |
| Fructose | 0.02 M | 0.02 M |
| EPC or EGCG or BHT | none | 0.01 M |

^{a}all reactants were placed in 350 ml of buffered (0.01 M phosphate) deionized water and heated for the time/temperature with a Parr Reactor (Model #4563) under constant stirring.

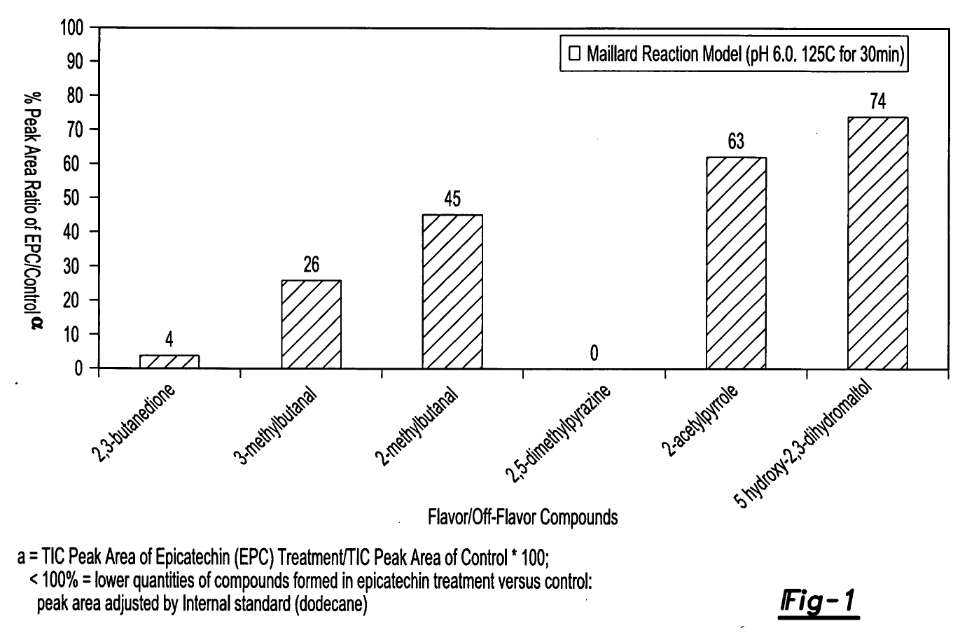

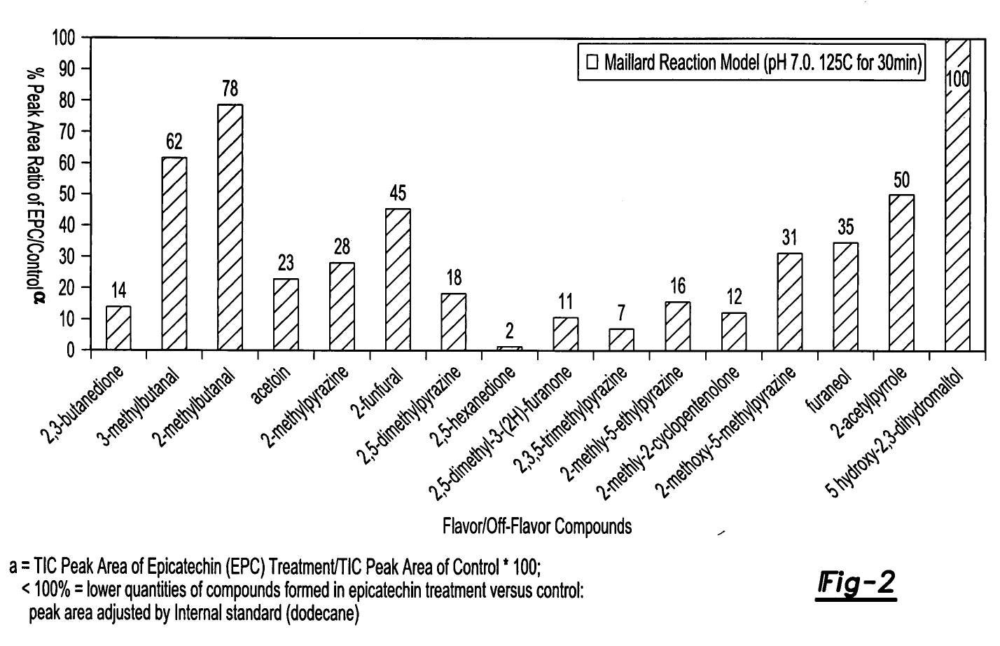

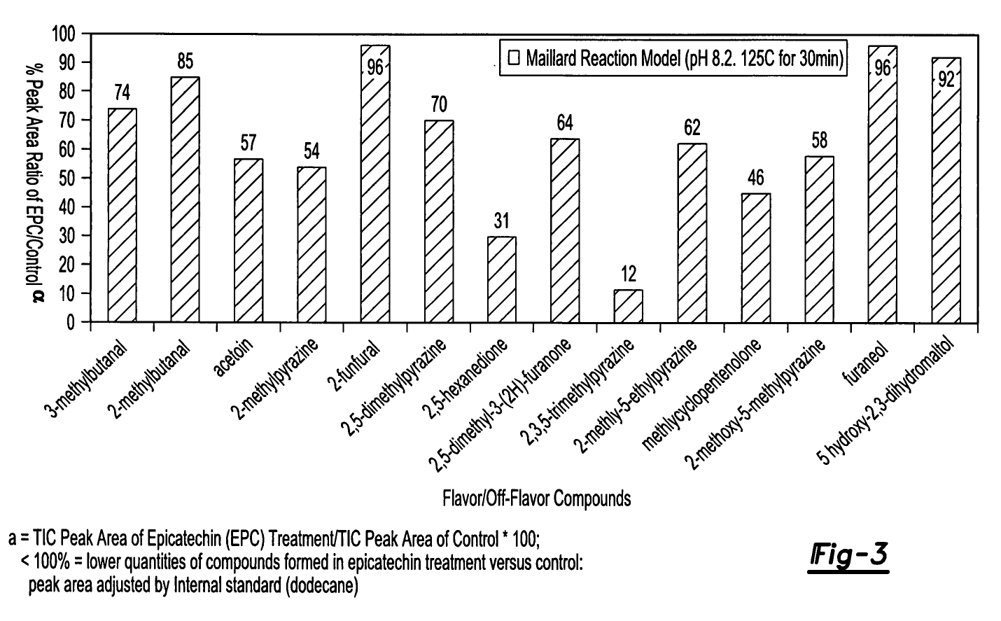

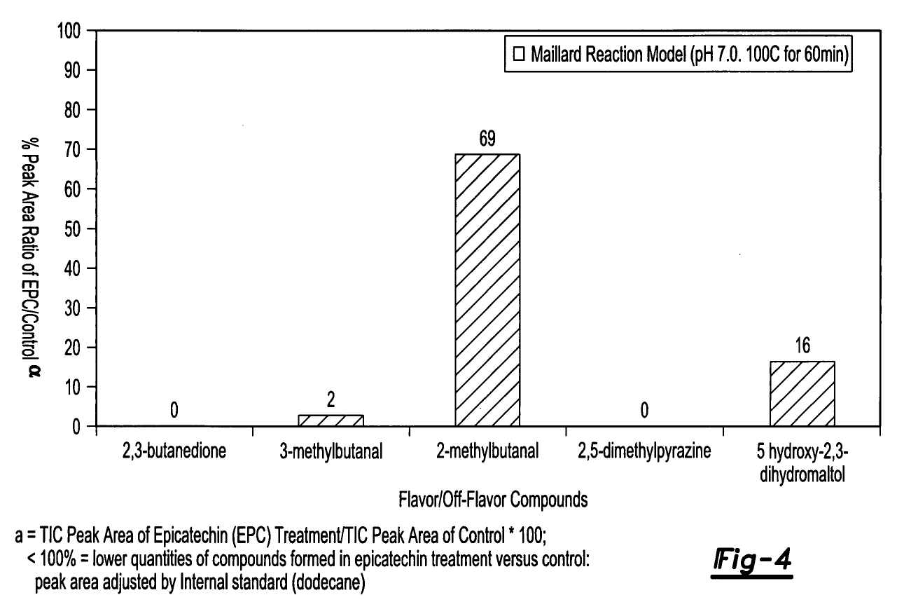

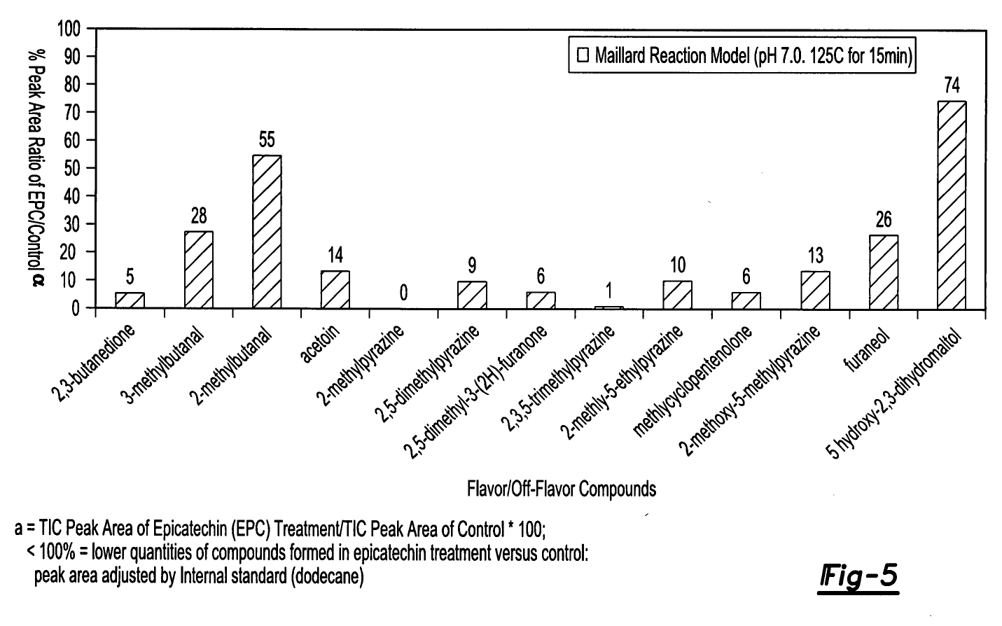

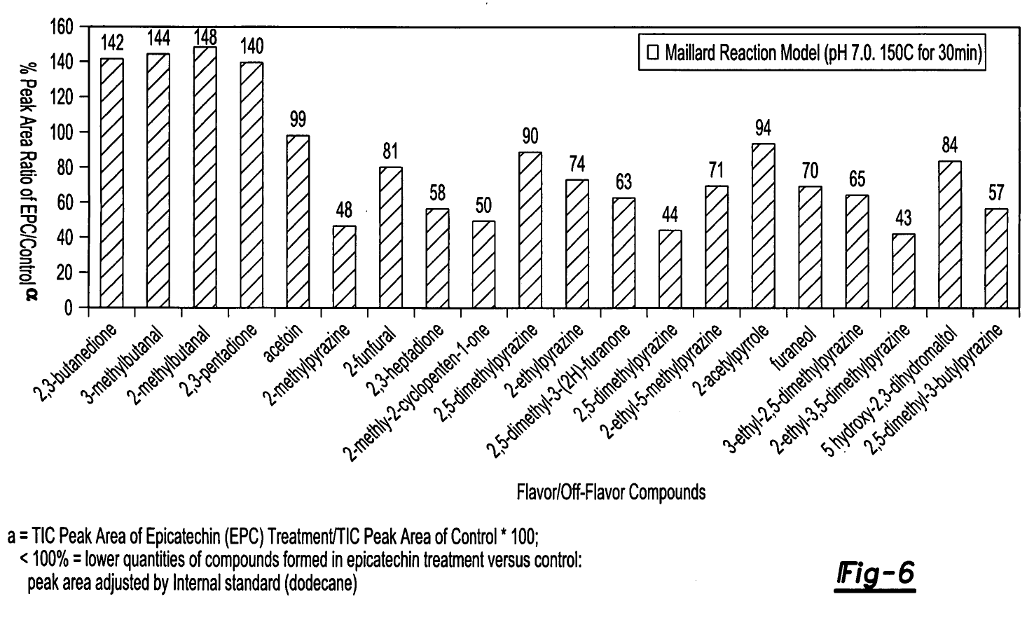

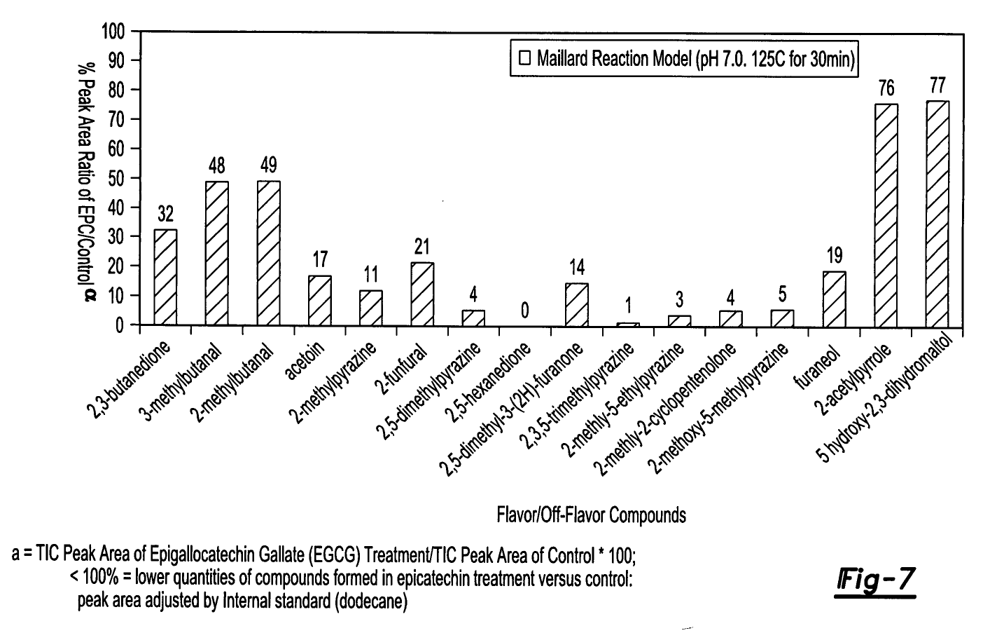

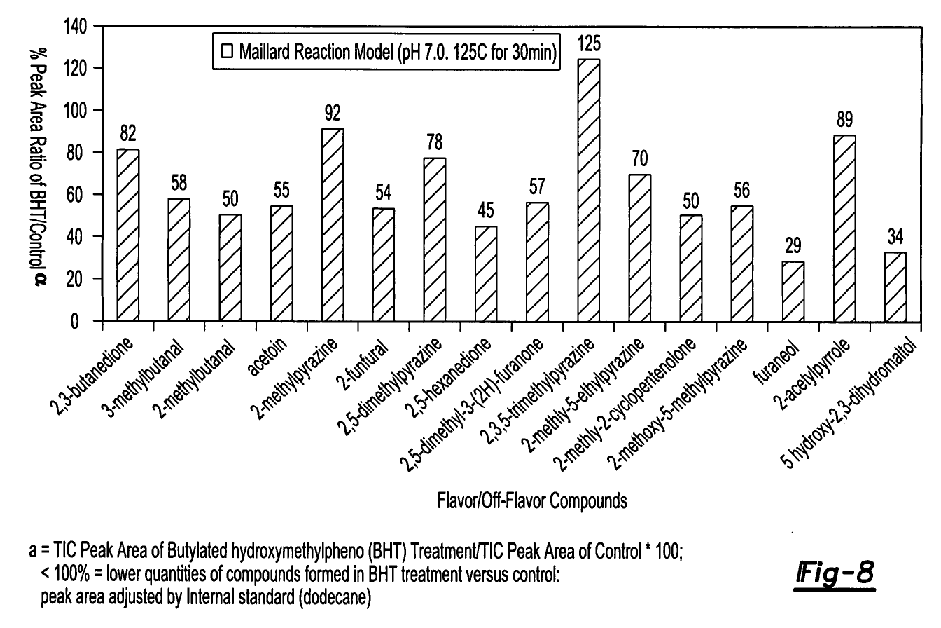

The mixture of Table 1 was subjected to a range of processing parameters: pH about 6-8.2, temperature approximately 100-150° C., reaction time approximately 15-60 minutes. The results are shown in FIGS. 1 to 8. Generally, under the conditions tested, addition of EPC and EGCG resulted in an overall reduction of common flavor compounds formed during the thermal treatment. Only one reaction temperature (150° C.) resulted in a small fraction of the flavor: pathways actually being catalyzed by EPC addition (4 of 20 flavor compounds identified increased in concentration). This data indicates that the addition/release of polyphenolic compounds, free radical scavengers, or antioxidants (i.e. epicatechin, epigallocatechin gallate, BHT) to food and beverage products which undergo processing conditions at temperatures lower than 150° C. may be used to limit flavor pathways (reduce flavor generation). At temperatures of 150° C. or higher, the addition/release of polyphenolic compounds, free radical scavengers, or antioxidant compounds to food and beverage products may be used to catalyze specific flavor pathways while limiting other flavor pathways (alter flavor properties).

Analytical protocol used was as follows: the final reaction mixture (300 ml aqueous solution) was extracted three times with 30 ml of high purity diethyl ether (containing 2.75 ppm dodecane as the internal standard). The extracts were pooled together, dried with anhydrous sodium sulfate and concentrated via fractional distillation techniques to approximately 0.5 ml. The resultant concentrates were analyzed by gas chromatography/mass spectrometry (Agilent 6890 gas chromatograph coupled to a HP5972 mass spectrometer in EI-mode). The GC/MS analysis parameters were as follows: 2 μl split injection (15:1); 30 m/0.25 mm/0.25 μm DB-5 ms column; temperature program at 35° C. for 2 minutes, ramp at 3° C. to 250° C.; column flow rate 0.7 ml/min; MS temperature=175° C.; GC injector temperature 200° C.

### Example 2

One day old bovine whole milk (control) and one day old bovine whole milk with three different levels (0.01, 0.1 & 0.2%) of EPC added were subjected to a temperature of approximately 138.3° C. for 6 seconds (typical UHT processing conditions). Sensory testing was performed to analyze the degree of cooked flavor perception in humans on all four samples of UHT milk (control+3 treatments) and commercial pasteurized milk. The results are shown in Table 2.

TABLE 2
Sensory Evaluation of Influence of EPC on the
Generation of “Cooked” Flavor in Milk During UHT Processing

| | | Tukey Grouping | | |
|---|---|---|---|---|
| | Sensory Score^{c} | (α = 0.05, | | |
| Sample | (Mean) | LSD = 1.61)^{d} | | |
| UHT Milk^{a} | 5.11 | A | | |
| UHT Milk + 0.01% EPC^{a} | 3.14 | | B | |
| UHT Milk + 0.1% EPC^{a} | 2.88 | | B | |
| UHT Milk + 0.2% EPC^{a} | 2.52 | | B | C |
| Pasteurized Milk^{b} | 1.19 | | | C |

^{a}raw milk with or without EPC as indicated (EPC was added prior to processing); processing conditions: Preheat to 87.8° C. → Homogenized (2500 psi) → Final Heat 141.1° C. → Hold 6 sec@138.3° C. → Cool to 16.7° C. → Fill → Refrigerated
^{b}commercial sample from local market
^{c}10 panelists were trained (6 sessions) on the flavor properties (“cooked” character) of pasteurized and UHT milk. The panelist ranked the samples on a scale of 1 to 15 with 1 as very low and 15 as very high cooked flavor. All samples were 3-digit coded and unmarked and the analysis was performed in duplicate.
^{d}same letter equal homogenous groups

All three UHT milk samples which contained EPC were significantly lower in cooked flavor in comparison to the control (UHT milk). Furthermore, one of the EPC enriched milk samples was not significantly different in cooked flavor in comparison to the commercial pasteurized milk sample. Pasteurized milk is considered to have a low/ml cooked flavor profile.

Analytical protocol was as follows: ten panelists were trained (six sessions) on the flavor properties (“cooked” character) of pasteurized and UHT milk (control sample). The panelist ranked the samples on a scale of 1 to 15 with 1 as very low and 15 as very high cooked flavor. All samples were 3-digit coded and unmarked and the analysis was preformed in duplicate. Samples were stored for three weeks at 1° C. prior to the final sensory analysis in amber colored glass bottled with a Teflon® closure.

### Example 2A

(Additional UHT Milk Data) One day old bovine whole milk (control) and one day old bovine whole milk with three different levels (0.01, 0.1 & 0.2%) of EPC added were subjected to a temperature of approximately 138.3° C. for 6 seconds (typical UHT processing conditions). Both sensory and chemical analyses were performed to characterize the influence of EPC addition on the flavor properties of UHT milk.

Sensory testing was performed to analyze the influence on EPC addition on the bitter attributes of EPC containing UHT milk by humans on all four samples of UHT milk (control+3 treatments) and commercial pasteurized milk. The results are shown in Table 2A. No significant difference in bitterness intensity was found at the 0.1% or less EPC level, however at 0.2% EPC level there was a small but significant increase in the perceived bitterness in comparison to the control (traditional UHT milk).

TABLE 2A
Sensory Evaluation of Influence of EPC on
Bitterness Perception in UHT Processed Milk

| | | |
|---|---|---|
| | | Tukey |
| | | Grouping |
| | | (α = 0.05, |
| | Sensory Score^{b} | LSD = |
| Sample | (Mean) | 1.78)^{c} |

| | | | |
|---|---|---|---|
| UHT Milk^{a} | 0.28 | A | |
| UHT Milk + 0.01% EPC^{a} | 0.19 | A | |
| UHT Milk + 0.1% EPC^{a} | 0.70 | A | |
| UHT Milk + 0.2% EPC^{a} | 3.30 | | B |

^{a}raw milk with or without EPC as indicated (EPC was added prior to processing); processing conditions: Preheat to 87.8° C. → Homogenized (2500 psi) → Final Heat 141.1° C. → Hold 6 sec@138.3° C. → Cool to 16.7° C. → Fill → Refrigerated
^{b}10 panelists were trained (6 sessions) on the bitter taste properties. The panelist ranked the samples on a scale of 1 to 15 with 1 as very low and 15 as very high cooked flavor. A 0.05%, 0.08% and 0.096% caffeine solution was used to anchor the 15 point scale at 2, 5 and 7 respectively. All samples were 3-digit coded and unmarked and the analysis was preformed in duplicate.
^{c}same letter equal homogenous groups

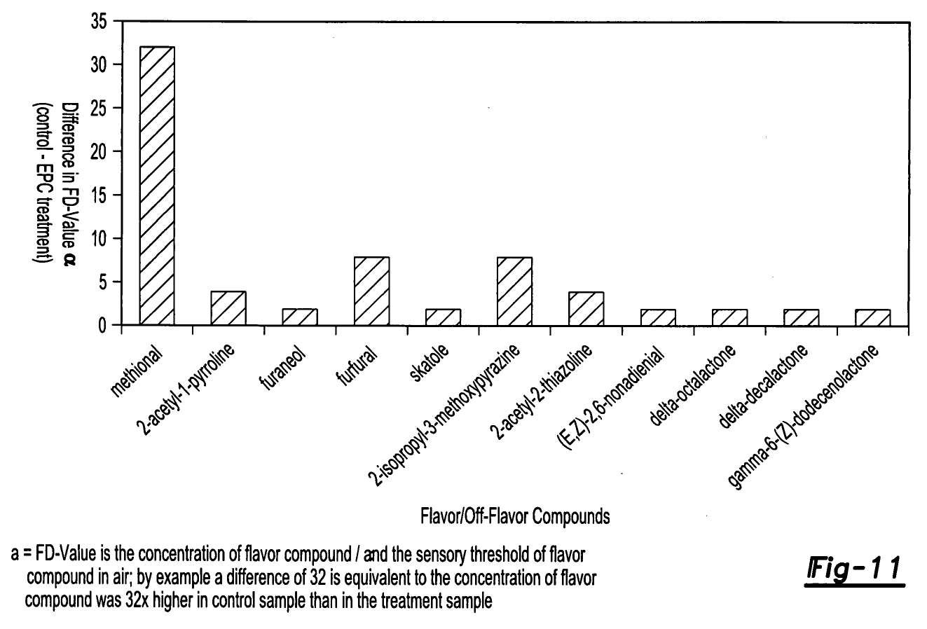

A chemical characterization of the key flavor (aroma) compounds responsible for the cooked flavor developed in fluid milk during UHT processing was conducted. The 0.1% EPC UHT milk treatment and the traditional UHT milk sample (control) were subjected to the gas chromatography-olfactometry technique Aroma Extract Dilution Analysis (AEDA) for the characterization of key odorants. This technique allows both the character and relative intensity of the odorants to be measured. The AEDA indicated that addition of EPC prior to UHT processing of raw fluid milk reduced the formation of key Maillard-type aroma-active compounds responsible for the cooked flavor of traditional UHT milk (see FIG. 11). Of the eleven flavor compounds identified to be generated during UHT processing conditions (responsible for “cooked” flavor properties), seven are Maillard-type flavor compounds (methional, 2-acetyl-1-pyyroline, furaneol, furfural, skatole, 2-isopropyl-3-methoxypyrazine, 2-acetyl-2-thiazoline) and showed the greatest inhibition by EPC addition. Smaller differences were observed for lipid oxidation or lipid thermal decomposition products ([E,Z]-2,6-nonadienal, delta-octalactone, delta-decalactone and gamma-9-[Z]-dodecenolactone).

Analytical protocol was as follows: milk samples were extracted 5× with 30 ml of high purity diethyl ether. The extracts were then pooled and concentrated to 100 ml via fraction distillation. The 100 ml extract was when subjected to solvent assisted flavor evaporation (SAFE; Engel, W., Bahr, W., Schieberle, P. 1999. Solvent assisted flavour evaporation—a new and versatile technique for the careful and direct isolation of aroma compounds from complex food matrices. Eur. Food Res. Technol. 209:237-241). The resultant isolate was dried with anhydrous sodium sulfate and further concentrated to approximately 200 μl for Aroma Extract Dilution Analysis (AEDA; Grosch, W. 1993. Detection of potent odorants in foods by aroma extraction dilution analysis. Trends in Fd. Sci. & Technol. 4:68-73). The GC-Olfactory (GCO) analysis parameters (for AEDA) were as follows: 1 μl splitless injection (2 minute); 30 m/0.25 mm/0.25 μm DB-5 ms column; temperature program at 30° C. for 2 minutes, ramp at 4° C. to 250° C.; column head pressure was maintained at 10 psi; GC injector temperature 200° C., GC injector temperature 200° C.; the effluent was split 1:1 between the FID and GC-O port.

### Example 3

The influence of addition of EPC to a granola bar mix (formulation shown in Table 3) prior to thermal processing on the flavor/off-flavor generation was studied.

TABLE 3
Granola Bar Formulation

| | |
|---|---|
| Control | EPC Enriched |

| Ingredient | % | Ingredient | % |
|---|---|---|---|
| Shortening | 15.4 | Shortening | 15.3 |
| Brown Sugar | 15.4 | Brown Sugar | 15.3 |
| Honey | 7.7 | Honey | 7.7 |
| Oats | 46.2 | Oats | 46.0 |
| Wheat Germ | 15.4 | Wheat Germ | 15.3 |
| | | Epicatechin | 0.3 |

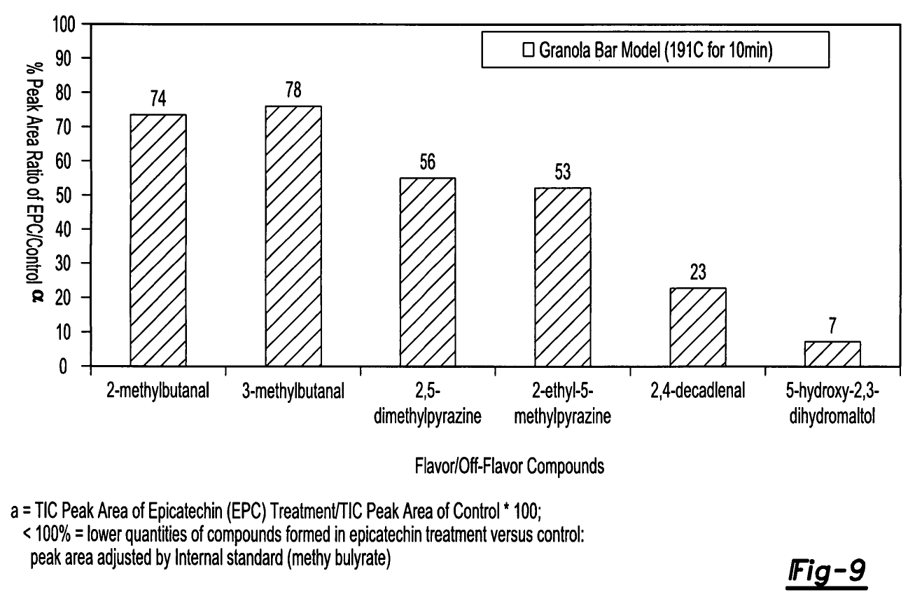

Approximately 100 g of the control and EPC-enriched samples was thermally processed at 191° C. for 10 minutes in a gravity oven. Noted differences in the thermal generation of known flavor compounds are shown in FIG. 9. Each of these compounds was found to be lower in concentration in the EPC enriched sample (lower flavor generation due to EPC addition). One significant difference was the decrease in the Amadori intermediate compound 5-hydroxy-2,3-dihydromaltol (86% decrease in peak area for EPC-enriched sample). This compound has been identified as a primary flavor precursor in Maillard reactions (Kim and Baltes. 1996. On the Role of 2,3-dihydro-3,5-dihydroxy-6-methyl-4(H)-pyran-4-one. J. Agric. Food Chem. 44, 282-289). The researchers reported this compound to be responsible for the formation of 37 different aromatic compounds by isotope labeling with 1³C to verify the precursor-products. The lipid oxidation product (2,4-decadienal), which is a well known powerful flavor/off-flavor compound, was also inhibited (formation) in the EPC-enriched sample.

Analytical protocol was as follows: the control and EPC enriched granola bar samples were ground separately using a Tekmar A-10 analytical mill. 40.0 g of each sample was analytically weighed into Erlenmeyer flasks. 70 ml of high purity diethyl ether was added to the flasks for 10 minutes before decanting the liquid into a separate flask. This step was repeated two more times for each sample. N-Octane-d₁₈ (99% Isotopic, Alfa Aesar, Ward Hill, Mass.) was added as the internal standard. High vacuum distillation (<10⁻³ Pa) was performed on the ether extract and the volatile fraction collected. The contents of the volatile fraction were dried with anhydrous sodium sulfate and then concentrated (spinning band distillation) to approximately 0.5 ml for analysis. The resultant concentrates were analyzed using gas chromatography/mass spectrometry (Agilent 6890 gas chromatograph coupled to a HP5972 mass spectrometer in EI-mode). The GC/MS analysis parameters were as follows: 1 μl splitless injection (1 minute); 60 m/0.25 mm/0.25 μm DB-5 ms column; temperature program at 35° C. for 4 minutes, ramp at 3° C. to 250° C.; column flow rate 0.8 ml/min; MS temperature=175° C.; GC injector temperature 200° C.

### Example 4

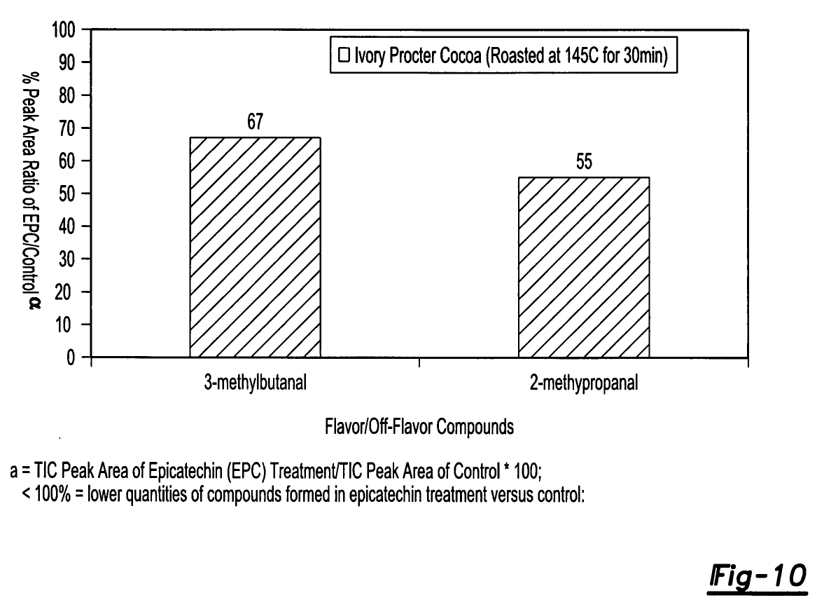

The influence of EPC addition to unroasted cocoa nibs on chocolate flavor development during roasting (thermal processing) was studied. A 200 g sample of unroasted Ivory Coast cocoa nibs was ground using a Tekmar A-10 analytical mill and subsequently split into two equal portions. 0.3% EPC was mixed with one of the portions. Both portions (control and treatment) were heated at about 145° C. for approximately 30 minutes (gravity oven). Differences in the thermal generation of previously reported character impact flavor compounds in milk chocolate/cocoa are shown in FIG. 10 (Schnennann and Schieberle. 1997. Evaluation of Key Odorants in Milk Chocolate and Cocoa Mass by Aroma Extract Dilution Analysis. J. Agric. Food Chem. 45: 867-872).

Analytical protocol was as follows: Approximately 2 grams of sample was analytically weighed into a 20 ml glass vial and sealed with a Teflon/silicon closure. SPME headspace analysis in conjunction with gas chromatography/mass spectrometry (Agilent 6890 gas chromatograph coupled to a HP5972 mass spectrometer in EI-mode) was used for analysis of the flavor compounds. The sample was incubated at about 40° C. for 1 hour prior to SPME sampling which was performed for about 1 minute with a DVB/Carboxen/PDMS fiber (Supelco, Bellefonte, Pa.). All measurements were performed in duplicate. The GC/MS analysis parameters were as follows: splitless injection (0.75 mm i.d. inlet liner); 60 m/0.25 mm/0.25 μm DB-5 ms column; temperature program at 35° C. for 4 minutes, ramp at 3° C. to 250° C.; column flow rate 0.8 ml/min; MS temperature=175° C.; GC injector temperature 250° C.

### Example 5

(Proposed Reactivity of Radical Scavenging Molecules and the Maillard Reaction) While not wishing to be bound by speculation, it is believed that the materials of the present invention act as radical scavengers and/or inhibit steps in the Maillard reaction. Our proposed chemically reactive forms of polyphenolic compounds, free radical scavengers, and/or antioxidants flavonoids (i.e. EPC, EGCG) in relation to the Maillard reaction are set forth below. 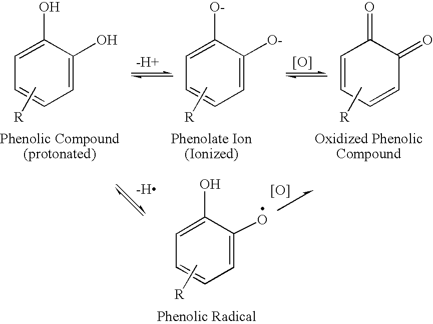
Review of these structures suggests chemical properties about of polyphenolic compounds, free radical scavengers, and/or antioxidants flavonoids (i.e. EPC, EGCG) that could be potentially reactive with respect to the thermal generation of aroma compound and include:
(1) relatively strong antioxidant property/free radical terminator;
(2) hydroxyl groups that can be oxidized to reactive carbonyl compounds; and
(3) a chemical structure which can form hydrophobic, hydrogen, ionic and covalent bonds.
   Furthermore, a reaction mechanism is also proposed to explain, in part, how polyphenolic compounds, free radical scavengers, and/or antioxidants flavonoids (i.e. EPC, EGCG) behave as reactants in Maillard-type flavor formation pathways with respect to the chemical property “relatively strong antioxidant property/free radical terminator”. This pathway illustrated below suggests how Amadori products, which are key flavor precursors of numerous flavor compounds, can be quenched by radical pathways or in the presence of flavonoids with radical terminating properties (antioxidant). 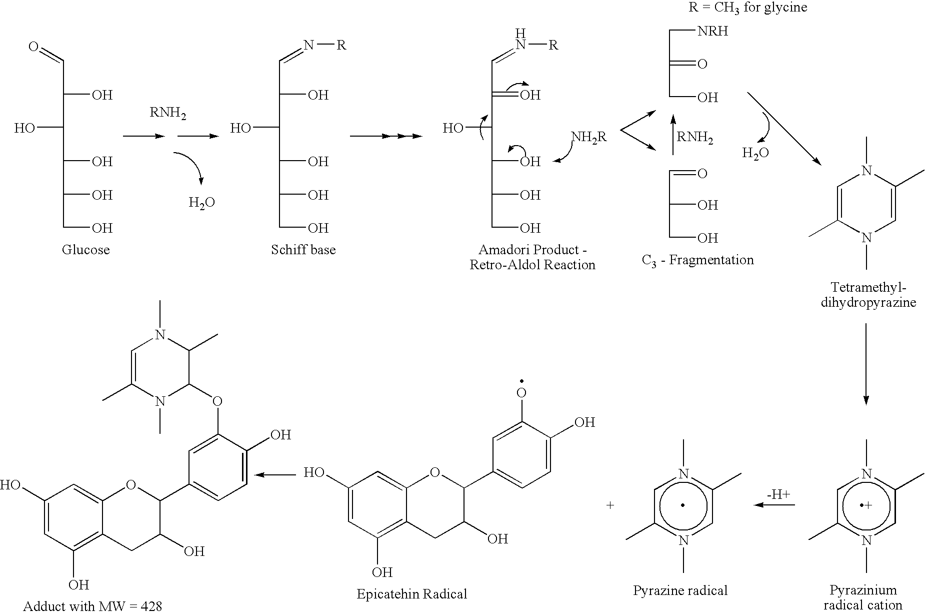
   The pyrazinium radical cation has been previously associated with color formation (polymerization) during the early stages of the Maillard reaction and is an alternative color formation route to the Hodge pathways (Hayashi, T. and M. Namiki. 1981. On the mechanisms of free radical formation during browning reaction of sugars with amino compounds. Agr. Biol. Chem. 45: 933-939; Hofmann, T., W. Bors, et al. (1999). Studies on radical intermediates in the early stage of the nonenzymatic reaction of carbohydrates and amino acids. J. Agric. Food Chem. 47: 379-390). We propose that the pyrazinium radical cation compound undergoes a deprotonation step to from the pyrazine radical which then undergoes a radical addition reaction with the epicatechin radical to form an adduct with a molecular weight of 428. Under the concept of La Chatelier's Principle, a higher proportion of Amadori product would be utilized via this pathway and therefore less is present for flavor development.

To analytically test this pathway, Maillard reaction models consisting of a glycine:glucose aqueous reaction mixtures (0.01 M each) with and without EPC were heated at 125° C. for 30 minutes and subsequently analyzed by HPLC-MS-ESI. This analysis confirmed the presence of a MW 428 compound in the EPC containing sample. No such species was found in the control. The MW428 peak for the EPC containing sample was doubled which suggests two different isomers; presumably adduct formation on the two different hydroxyl groups on the B-ring. Further evidence of this epicatechin-pyrazine adduct was evident by comparing the theoretical natural isotope abundance of ¹³C=25.4% and the MS spectra calculated value=25.8%.

Analytical Protocol as Follows:

Model system: Two model Maillard reaction systems comprising of glucose-glycine (control) with the addition of epicatechin (treatment) in phosphate buffer (350 ml, pH 7.0) were heated (Parr reactor) at 125° C. for 30 min. All reactants were at 0.01 M. The reaction mixture was subsequently analyzed by High Performance Liquid Chromatography Electrospray Ionization Mass Spectrometry (HPLC-ESI-MS).

HPLC: HPLC-MS analyses were performed in an HPLC/MS system equipped with a pump (LC-10 ADvp pump (Shimadzu, Columbia, Md.)), an autoinjector (CTC PAL-HTC autosampler (Leap Technologies)) and Quattro II mass spectrometer (Micromass, Beverly, Mass.) equipped with electrospray ionization. Data was collected simultaneously collected using the Mass Lynx software (V3.5) (Micromass Limited, Manchester, UK). Separation were achieved on a 1011 injections using a 1×150 mm, 5 μm packing, BetaBasic C18 column (ThermoHypersil Keystone, Bellefonte, Pa.) using a binary mobile system by of A (99% water) and B (1% methanol) and a flow rate 0.15 ml/min. A series of linear gradients of B into A were applied to maximize resolution as follows: elution starting at 1% B into A (2-15 min); 99% B into A (15-18 min), 1% B into A (18.01-20 min). Mass spectrometric data was collected in a negative ion mode using the following conditions: capillary voltage (3.0 Kvolts); scan range (20 to 1500 Da); source temperature (100° C.).

While the invention has been particularly shown and described with reference to preferred embodiments thereof, it will be understood by those skilled in the art that various alterations in form and detail may be made therein without departing from the spirit and scope of the invention. For example, while the use of certain polyphenolic compounds has been disclosed herein, the invention is not limited to these materials. Other polyphenols, which may or may not be catechins, may be employed in the practice of this invention. Likewise, other free radical scavengers can be advantageously employed. It is the following claims, including all equivalents, which define the scope of the invention.

1. A method for controlling the development of flavor compounds in a food, said method comprising the steps of:
adding a flavonoid compound to said food; and
heating said food.

2. The method of claim 1, wherein said flavonoid compound is a phenolic compound.

3. The method of claim 1, wherein said flavonoid compound is a polyphenolic compound.

4. The method of claim 3, wherein said polyphenolic compound is a catechin.

5. The method of claim 3, wherein said polyphenolic compound is selected from the group consisting of epicatechin (EPC), epigallocatechin gallate (EGCG), and combinations thereof.

6. The method of claim 1, wherein said flavonoid compound is added before the step of heating said food.

7. The method of claim 1, wherein said flavonoid compound is added after heating said food.

8. The method of claim 1, wherein the step of adding said flavonoid compound to said food comprises adding up to 2% by weight of said flavonoid compound to said food.

9. The method of claim 8, wherein said step of adding said flavonoid compound to said food comprises adding at least 0.2% by weight of said flavonoid to said food.

10. The method of claim 1, wherein said flavonoid compound is a free radical scavenger.

11. The method of claim 1, wherein the step of heating said food comprises heating said food to a temperature of up to 150° C.

12. A method for controlling the development of flavor compounds during the processing or storage of foods, said method comprising the step of:
at least partially blocking a Maillard reaction pathway in said food.

13. The method of claim 12, wherein the step of at least partially blocking said Maillard reaction pathway comprises adding a radical scavenger to said food.

14. The method of claim 13, wherein said radical scavenger comprises a flavonoid.

15. The method of claim 13, wherein said radical scavenger is a polyphenolic compound.

16. The method of claim 12 including the further step of heating said food.

17. The method of claim 12 including the further step of storing said food wherein said Maillard reaction pathway is at least partially blocked during a portion of the time said food is being stored.

18. A method for controlling the development of flavor compounds during the processing or storage of foods, said method comprising the step of:
scavenging pyrazine radicals in said food.

19. The method of claim 18, wherein said step of scavenging pyrazine radicals comprises adding a radical scavenger to said food.

20. The method of claim 19, wherein said radical scavenger is a flavonoid.

21. The method of claim 19, wherein said radical scavenger is a polyphenolic compound.

22. The method of claim 18 including the further step of heating said food.

23. The method of claim 18 including the further step of storing said food wherein the step of scavenging said pyrazine radicals is carried out during at least a portion of the time said food is being stored.

24. The method of claim 1, wherein the step of adding said flavonoid compound to said food comprises adding 0.01-0.2% by weight of said flavonoid to said food.

25. The method of claim 1, wherein the step of adding said flavonoid compound to said food comprises adding 0.01-0.1% by weight of said flavonoid to said food.

26. The method of claim 25, wherein said food is milk.

27. The method of claim 1, wherein said food is milk, and said step of adding said flavonoid compound to said milk comprises adding 0.1% by weight of said flavonoid compound to said milk.
